(19) United States
(12) Patent Application Publication
(10) Pub. No.: US 2012/0099467 A1
(43) Pub. Date: Apr. 26, 2012

(54) RADIO BASE STATION AND RESOURCE ALLOCATING METHOD

(75) Inventor: Chiharu Yamazaki, Yokohama-shi (JP)

(73) Assignee: KYOCERA CORPORATION, Kyoto (JP)

(21) Appl. No.: 13/379,554

(22) PCT Filed: Jun. 25, 2010
(86) PCT No.: PCT/JP2010/060906

§ 371 Date: Dec. 20, 2011

(30) Foreign Application Priority Data
Jun. 25, 2009 (JP) 2009-151661

(51) Int. Cl. H04W 72/04; H04W 24/00; H04L 12/26

(52) U.S. Cl. 370/252

(57) ABSTRACT

A radio base station (100) comprises a processor (120) for allocating, to a radio terminal, any of a plurality of frequency resources on the basis of channel information indicating a channel quality between the radio terminal and the radio base station (100). The processor (120) periodically acquires the respective pieces of channel information of the plurality of frequency resources, then averages the acquired pieces of channel information in the frequency direction and in the time direction to calculate average channel information, and then calculates, based on the channel information and the average channel information, an evaluation value to be used for deciding a frequency resource. In a particular time frame for which the calculation of evaluation value can be omitted, the processor (120) uses the channel information of some of the plurality of frequency resources to calculate average channel information or omit the calculation of average channel information.

### TECHNICAL FIELD

The present invention relates to a radio base station and a resource allocating method for allocating a radio resource such as a frequency resource and a time resource to a radio terminal.

### BACKGROUND ART

In a radio communication system, allocation processing in consideration of a channel quality between a radio base station and a radio terminal has been widely used to efficiently allocate limited radio resources (frequency resources or time resources) to plural radio terminals. To be specific, the radio base station acquires a channel information piece indicating the channel quality for each radio resource and determines a radio resource to be allocated to the radio terminal by using an evaluation value based on the acquired channel information piece.

In recent years, a proportional fairness scheme (see, for example, Patent Document 1) has been becoming predominant as a method for the above allocation processing. The proportional fairness scheme is a scheme of preferentially allocating a radio terminal a radio resource with a higher evaluation value represented by a ratio of a channel information piece of each radio resource to an average value (hereinafter referred to as “average channel information”) of channel information pieces of respective radio resources (i.e., channel information piece/average channel information).

The proportion fairness scheme can provide (radio terminals with) fair opportunities of radio resource allocation by using the average channel information to calculate the evaluation value, and also can improve the throughput by allocating a radio resource with a high channel quality based on a result of the calculation of the evaluation value using the channel information piece of each radio resource.

### PRIOR ART DOCUMENT

### Non-Patent Document

Patent Document 1: Japanese Patent Application Publication No. 2006-157323

### SUMMARY OF THE INVENTION

The proportional fairness scheme can provide the fair allocation opportunities by using the average channel information to calculate the evaluation value. However, the average channel information needs to be calculated by averaging the channel information pieces of radio resources. Thus there is a problem that a large processing load attributable to the calculation of the average channel information is imposed on the radio base station.

There is a problem that, under the presence of a large number of radio terminals with which the radio base station is to communicate, the radio base station bears a huge processing load when calculating the average channel information for each of the large number of radio terminals.

Thus, an object of the present invention is to provide a radio base station and a resource allocating method that achieves reduction in a processing load attributable to the calculation of the average channel information in the case of performing the allocation processing based on the average channel information.

The present invention has the following features to solve the problems described above. First of all, a first feature of the present invention is summarized as a radio base station (radio base station 100) comprising an allocation processor (processor 120) configured to allocate any of a plurality of frequency resources to a radio terminal (radio terminal UE) on the basis of a channel information piece indicating a channel quality between the radio terminal and the radio base station, the allocation processor configured to: periodically acquire the channel information piece of each of the plurality of frequency resources, calculate average channel information by averaging the acquired channel information pieces in a frequency direction and a time direction, and calculate an evaluation value to be used for determining a frequency resource to be allocated to the radio terminal on the basis of the acquired channel information pieces and the calculated average channel information. In a specific time period in which the calculation of the evaluation value is omissible, the allocation processor calculates the average channel information using the channel information pieces of some of the plurality of frequency resources or omits the calculation of the average channel information.

According to such a feature, the average channel information is calculated using the channel information pieces of the some frequency resources in the plural frequency resources or the calculation of the average channel information is omitted in the specific time period in which the calculation of the evaluation value can be omitted. Thus, it is possible to reduce a processing load attributable to the calculation of the average channel information.

In the aforementioned feature of the present invention, the specific time period may be a time period in which there is no data to be transmitted to or to be received from the radio terminal using any of the plurality of frequency resources.

In the aforementioned feature of the present invention, the specific time period may be a time period in which any of the plurality of frequency resources is reserved for allocation to the radio terminal.

In the aforementioned feature of the present invention, hybrid automatic repeat request, which is a combination of forward error correction and automatic repeat request, is employed for communications between the radio base station and the radio terminal, and the specific time period may be a time period in which the number of retransmission processes performed in parallel based on the hybrid automatic repeat request is at a maximum number.

In the aforementioned feature of the present invention, if the average channel information is calculated using the channel information pieces of the some frequency resources, the allocation processor may acquire the channel information pieces of the some frequency resources.

In the aforementioned feature of the present invention, if the calculation of the average channel information is omitted, the allocation processor may omit the acquisition of the channel information pieces.

In the aforementioned feature of the present invention, if the calculation of the average channel information is omitted, and if a time period of omitting the calculation of the average channel information continues for a predetermined period, the allocation processor may calculate the average channel information using the channel information pieces of the some frequency resources.

A second feature of the present invention is summarized as a radio base station (radio base station 100) comprising an allocation processor (processor 120) configured to allocate any of a plurality of time resources to a radio terminal (radio terminal UE) on the basis of a channel information piece indicating a channel quality between the radio terminal and the radio base station, the allocation processor configured to acquire the channel information piece of each of the plurality of time resources, calculate average channel information by averaging the acquired channel information pieces, and calculate an evaluation value to be used for determining a time resource to be allocated to the radio terminal on the basis of the acquired channel information pieces and the calculated average channel information. In a specific time period in which the calculation of the evaluation value is omissible, the allocation processor omits the calculation of the average channel information.

According to such a feature, the calculation of the average channel information is omitted in the specific time period in which the calculation of the evaluation value can be omitted. Thus, it is possible to reduce a processing load attributable to the calculation of the average channel information.

A third feature of the present invention is summarized as a resource allocating method for allocating any of a plurality of frequency resources to a radio terminal on the basis of a channel information piece indicating a channel quality between the radio terminal and the radio base station, the resource allocating method comprising: an acquisition step of periodically acquiring the channel information piece of each of the plurality of frequency resources; a first calculation step of calculating average channel information by averaging the channel information pieces, acquired in the acquisition step, in a frequency direction and a time direction; and a second calculation step of calculating an evaluation value to be used for determining a frequency resource to be allocated to the radio terminal, on the basis of the channel information pieces acquired in the acquisition step and the average channel information calculated in the first calculation step. In a specific time period in which the calculation of the evaluation value is omissible in the second calculation step, the first calculation step includes calculating the average channel information using the channel information pieces of some of the plurality of frequency resources or omitting the calculation of the average channel information.

A fourth feature of the present invention is summarized as a resource allocating method for allocating any of a plurality of time resources to a radio terminal on the basis of a channel information piece indicating a channel quality between the radio terminal and the radio base station, the resource allocating method comprising: an acquisition step of acquiring the channel information piece of each of the plurality of time resources; a first calculation step of calculating average channel information by averaging the channel information pieces acquired in the acquisition step; and a second calculation step of calculating an evaluation value to be used for determining a time resource to be allocated to the radio terminal, on the basis of the channel information pieces acquired in the acquisition step and the average channel information calculated in the first calculation step. In a specific time period in which the calculation of the evaluation value is omissible in the second calculation step, the first calculation step includes omitting the calculation of the average channel information.

Features of the present invention can provide the radio base station and the resource allocating method that can reduce a processing load attributable to the calculation of the average channel information when the allocation processing based on the average channel information is performed.

### BRIEF DESCRIPTION OF THE DRAWINGS

FIG. 1 is a schematic configuration diagram of a radio communication system according to an embodiment of the present invention.

FIG. 2 is a block diagram showing a configuration of a radio base station according to the embodiment of the present invention.

FIG. 3 is a diagram for explaining a method for calculating average channel information according to the embodiment of the invention.

FIG. 4 is a flowchart showing a processing flow 1 of allocation processing performed by a processor according to the embodiment of the present invention.

FIG. 5 is a flowchart showing a processing flow 1 of allocation processing performed by a processor according to the embodiment of the present invention.

FIG. 6 is a diagram for explaining a method for calculating average channel information according to other embodiments.

### DESCRIPTION OF THE EMBODIMENTS

An embodiment of the present invention is described below with reference to the drawings. To be specific, the description is given on (1) Overview of Radio Communication System, (2) Configuration of Radio Base Station, (3) Processing Flows, (4) Effects of the Embodiment, and (5) Other Embodiments. Note that, in the following description of the drawings, same or similar reference signs denote same or similar elements and portions.

### (1) Overview of Radio Communication System

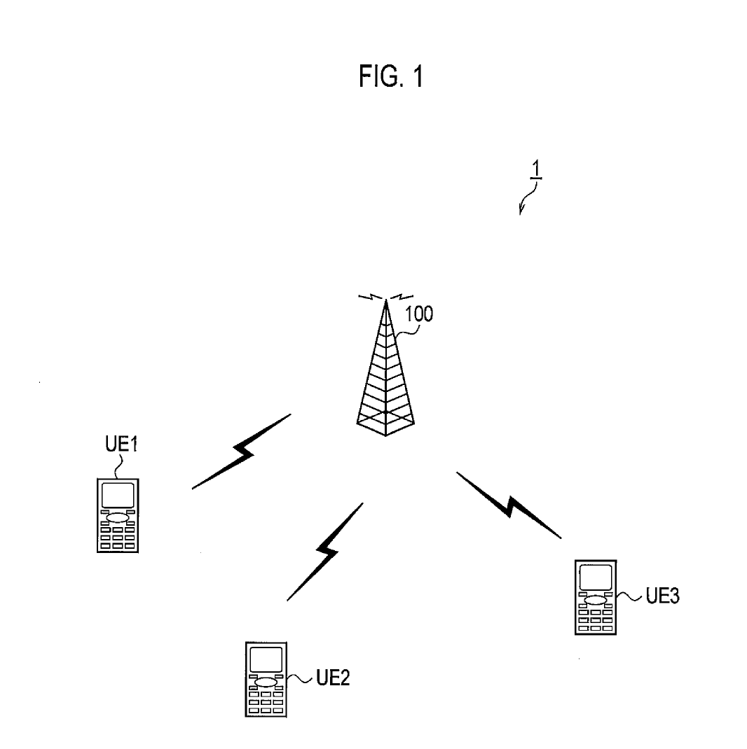

FIG. 1 is a schematic configuration diagram of a radio communication system 1 according to an embodiment of the present invention.

In the present embodiment, the radio communication system 1 is an FDMA radio communication system using, as a multiple access scheme, an FDMA scheme such as an orthogonal frequency division multiple access (OFDMA) scheme and a single carrier frequency division multiple access (SC-FDMA) scheme. For example, the radio communication system 1 has a configuration based on E-UTRA (Evolved-Universal Terrestrial Radio Access) standardized in 3GPP (3rd Generation Partnership Project).

In the radio communication system 1, a system band is divided into plural frequency resources (subchannels) to be used in each subframe. In E-UTRA, each frequency resource in each subframe is referred to as a resource block (RB).

As shown in FIG. 1, the radio communication system 1 includes plural radio terminals UE1, UE2, UE3, and so forth and a radio base station 100. In the following description, one of the radio terminals UE1, UE2, UE3, and so forth is simply referred to as “radio terminal UE” as appropriate. For each subframe, the radio base station 100 allocates a frequency resource to each of the radio terminals UE1, UE2, UE3, and so forth and performs radio communications using the allocated radio resources.

Generally, a channel quality between the radio base station 100 and the radio terminal UE differs among frequencies. Thus, the radio base station 100 performs allocation processing to preferentially allocate a frequency resource with an excellent channel quality to the radio terminal UE. The allocation processing is performed on each of the radio terminals UE1, UE2, UE3, and so forth, whereby the system band can be efficiently used.

For the down link, the radio terminal UE measures a channel quality for each frequency resource on the basis of a down link radio signal (to be specific, a pilot signal of a known signal sequence) received from the radio base station 100. The radio terminal UE transmits to the radio base station 100, a CQI (Channel Quality Indication) indicating the measured channel quality for each frequency resource and each subframe. The radio base station 100 performs the frequency resource allocation processing based on the CQI received from the radio terminal UE.

For the up link, the radio base station 100 measures a SINR (Signal-to-Interference and Noise Power Ratio) indicating a channel quality for each frequency resource and each subframe on the basis of an up link radio signal (to be specific, a pilot signal of a known signal sequence) received from the radio terminal UE. The radio base station 100 performs the frequency resource allocation processing based on the measured SINR.

In the present embodiment, each of the CQI and the SINR is a channel information piece indicating a channel quality (instantaneous channel quality) of a frequency resource.

The radio base station 100 performs the allocation processing based on a proportional fairness scheme in each of the down link and the up link. The radio base station 100 calculates an evaluation value using average channel information obtained by averaging the channel information pieces for respective frequency resources in the frequency direction and in the time direction. The radio base station 100 preferentially allocates the radio terminal UE a frequency resource with a high evaluation value represented by a ratio of the channel information piece of each frequency resource to the average channel information (i.e., channel information piece of each frequency resource/average channel information).

### (2) Configuration of Radio Base Station

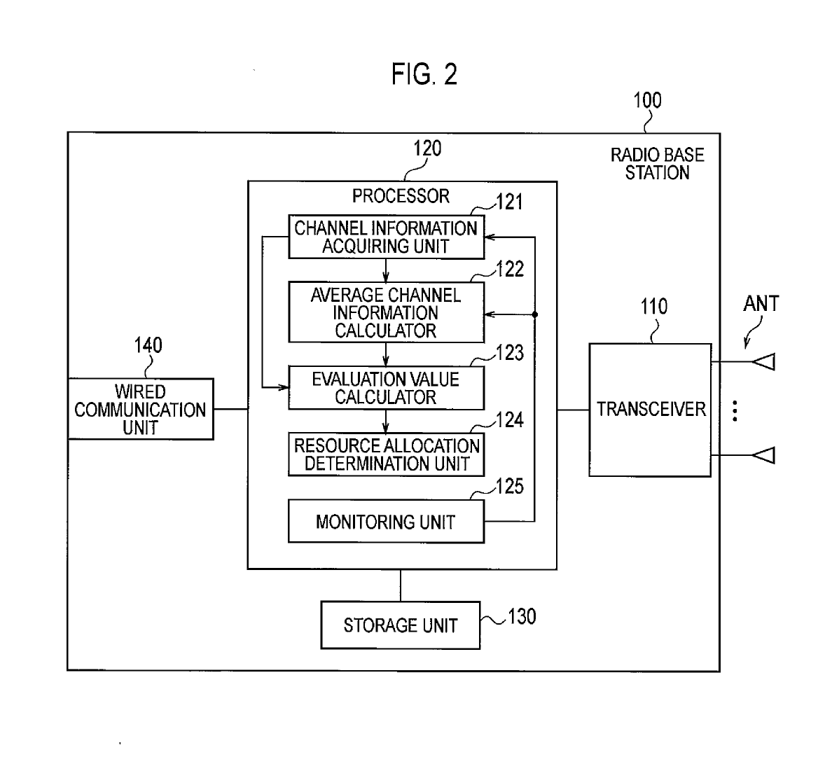

FIG. 2 is a block diagram showing a configuration of the radio base station 100.

As shown in FIG. 2, the radio base station 100 includes antennas ANT, a transceiver 110, a processor 120, a storage unit 130, and a wired communication unit 140.

The transceiver 110 is formed of an RF circuit or a BB circuit for example and transmits and receives a radio signal through the antennas ANT and performs modulation/demodulation and encoding/decoding.

The processor 120 is formed of a CPU for example and controls various functions of the radio base station 100 and performs various calculations. In the present embodiment, the processor 120 forms an allocation processor that allocates one of plural frequency resources to the radio terminal UE on the basis of a channel information piece.

The storage unit 130 is formed of a memory for example, and stores therein various information pieces used for controlling the radio base station 100, the calculation, and the like. The storage unit 130 also serves as a transmission buffer that holds transmission data to be transmitted by the transceiver 110 until the transmission is completed. The wired communication unit 140 communicates with other apparatuses (radio base station and a controller) through a backhaul network.

The processor 120 includes a channel information acquiring unit 121, an average channel information calculator 122, an evaluation value calculator 123, a resource allocation determination unit 124, and a monitoring unit 125.

The channel information acquiring unit 121 acquires a channel information piece for each of frequency resources F1, F2, F3 and so forth in each subframe (i.e., periodically). The acquired channel information piece may be a channel information piece for each frequency resource in the down link or a channel information piece for each frequency resource in the up link.

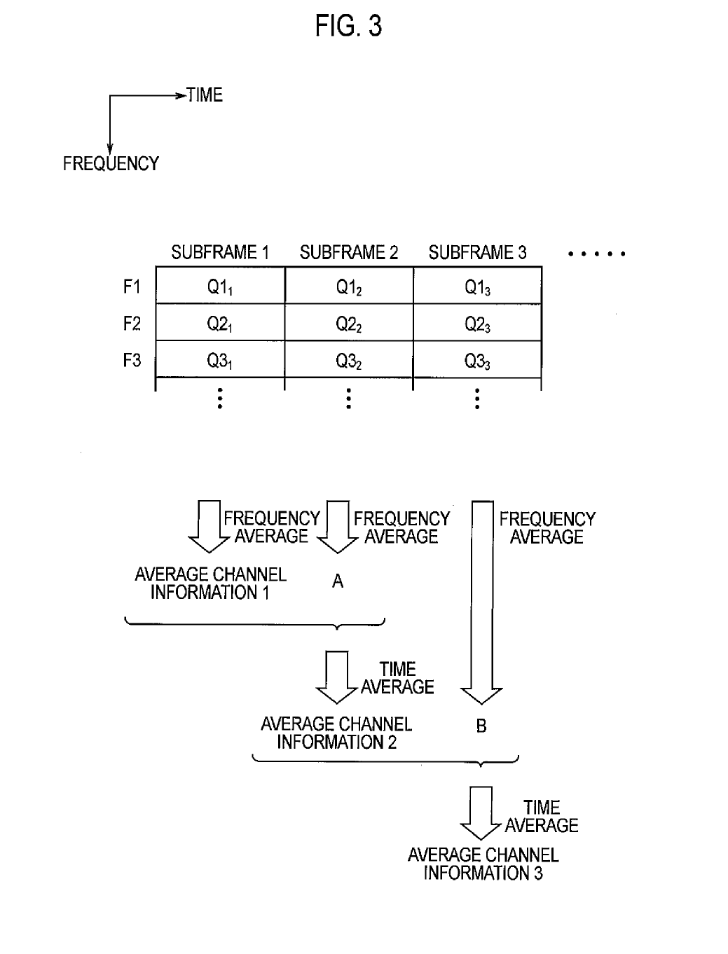

In the example of FIG. 3, the channel information acquiring unit 121 acquires a channel information piece Q1₁ of the frequency resource F1, a channel information piece Q2₁ of the frequency resource F2, and a channel information piece Q3₁ of the frequency resource F3, in a subframe 1.

In addition, the channel information acquiring unit 121 acquires a channel information piece Q1₂ of the frequency resource F1, a channel information piece Q2₁ of the frequency resource F2, and a channel information piece Q3₂ of the frequency resource F3, in a subframe 2.

The channel information acquiring unit 121 acquires a channel information piece Q1₃ of the frequency resource F1, a channel information piece Q2₃ of the frequency resource F2, and a channel information piece Q3₃ of the frequency resource F3, in a subframe 3.

The channel information acquiring unit 121 performs such acquiring processing on each of the radio terminals UE1, UE2, UE3 and so forth.

As shown in FIG. 3, the average channel information calculator 122 calculates the average channel information by averaging the channel information pieces acquired by the channel information acquiring unit 121 in the frequency direction and the time direction.

In the example of FIG. 3, the average channel information calculator 122 calculates the average value of the channel information pieces Q1₁, Q2₁, Q3₁ and so forth of the respective frequency resources F1, F2, F3 and so forth as average channel information 1 in the subframe 1. The calculated average channel information 1 is stored in the storage unit 130.

In addition, the average channel information calculator 122 calculates the average value A of the channel information pieces Q1₂, Q2₂, Q3₂ and so forth of the respective frequency resources F1, F2, F3 and so forth in the subframe 2. Further, the average channel information calculator 122 calculates an average value of the average value A in the frequency direction and the average channel information 1 stored in the storage unit 130 as average channel information 2 in the subframe 2. The calculated average channel information 2 is stored in the storage unit 130.

The average channel information calculator 122 calculates the average value B of the channel information pieces Q1₃, Q2₃, Q3₃ and so forth of the respective frequency resources F1, F2, F3 and so forth in the subframe 3. Further, the average channel information calculator 122 calculates an average value of the average value B in the frequency direction and the average channel information 2 stored in the storage unit 130 as average channel information 3 in the subframe 3. The calculated average channel information 3 is stored in the storage unit 130.

The average channel information calculator 122 performs the averaging on each of the radio terminals UE1, UE2, UE3, and so forth. The averaging involves calculation such as conversion between decibel (dB) and a true value, and thus a large processing load is imposed on the processor 120.

The average channel information stored in the storage unit 130 is updated for each subframe by the average channel information calculator 122.

The evaluation value calculator 123 calculates an evaluation value to be used for determining the frequency resource to be allocated to the radio terminal UE for each of the frequency resources F1, F2, F3, and so forth. The calculation is based on the channel information piece acquired by the channel information acquiring unit 121 and the average channel information calculated by the average channel information calculator 122.

In the example of FIG. 3, the evaluation value calculator 123 calculates the channel information piece Q1₁/the average channel information 1 as an evaluation value corresponding to the frequency resource F1 in the subframe 1. The evaluation value calculator 123 calculates the channel information piece Q2₁/the average channel information 1 as an evaluation value corresponding to the frequency resource F2. The evaluation value calculator 123 calculates the channel information piece Q3₁/the average channel information 1 as an evaluation value corresponding to the frequency resource F3.

In addition, the evaluation value calculator 123 calculates the channel information piece Q1₁/the average channel information 2 as an evaluation value corresponding to the frequency resource F1 in the subframe 2. The evaluation value calculator 123 calculates the channel information piece Q2₂/the average channel information 2 as an evaluation value corresponding to the frequency resource F2. The evaluation value calculator 123 calculates the channel information piece Q3₂/the average channel information 2 as an evaluation value corresponding to the frequency resource F3.

The evaluation value calculator 123 calculates the channel information piece Q1₃/the average channel information 3 as an evaluation value corresponding to the frequency resource F1 in the subframe 3. The evaluation value calculator 123 calculates the channel information piece Q2₃/the average channel information 3 as an evaluation value corresponding to the frequency resource F2. The evaluation value calculator 123 calculates the channel information piece Q3₃/the average channel information 3 as an evaluation value corresponding to the frequency resource F3.

The evaluation value calculator 123 performs the evaluation value calculation on each of the radio terminals UE1, UE2, UE3, and so forth.

The evaluation value calculator 123 may calculate an evaluation value on the basis of the channel information (i.e., short period average channel information) obtained by averaging in the time direction and the average channel information (long period average channel information) obtained by averaging in the frequency direction and the time direction. The short period average channel information is obtained by averaging in a shorter period than that for the average channel information (i.e., long term average channel information).

The resource allocation determination unit 124 determines the frequency resource to be allocated to each of the radio terminals UE1, UE2, UE3, and so forth on the basis of the evaluation values calculated by the evaluation value calculator 123. In the example of FIG. 3, the resource allocation determination unit 124 compares the evaluation values of the frequency resource Fn calculated for each of the radio terminals UE1, UE2, UE3, and so forth in each subframe. Then, the frequency resource Fn is allocated to the radio terminal UE with the highest evaluation value.

The monitoring unit 125 monitors whether each of the radio terminals UE1, UE2, UE3, and so forth is in a specific time period in which the evaluation value calculator 123 can omit the calculation of the evaluation value (i.e., allocation of the frequency resource does not need to be determined).

The specific time period is any one of (a) to (c) described below.

(a) A subframe without data (user data) to be transmitted and received to and from the radio terminal UE using a frequency resource.

For the down link, the monitoring unit 125 can detect the subframe without data to be transmitted to the radio terminal UE from the transceiver 110 by monitoring whether data destined to the radio terminal UE is stored in the storage unit 130. For the up link, the radio terminal UE notifies a transmission buffer amount in the radio terminal UE, and the monitoring unit 125 detects the subframe without data to be received by the transceiver 110 from the radio terminal UE by monitoring whether data destined to the radio base station 100 is stored in the radio terminal UE.

(b) A subframe in which a frequency resource to be allocated to the radio terminal UE is reserved.

In some cases, a frequency resource to be allocated to a specific radio terminal UE is reserved at a predetermined time interval to ensure a Qos for example. The monitoring unit 125 detects the subframe in which a frequency resource allocated to the radio terminal UE is reserved by monitoring such a resource reservation condition.

(c) A subframe in which a hybrid automatic repeat request (HARQ) process number is at the maximum number.

HARQ, which is a combination of forward error correction (FEC) and automatic repeat request (ARQ), is employed for communications between the radio base station 100 and the radio terminal UE. The HARQ process number is the number of retransmission processes executed in parallel on the basis of the HARQ. No resource can be allocated in a time period in which the HARQ process number is at the maximum number, the time period ending when next retransmission becomes possible in each process. The monitoring unit 125 detects the subframe in which the HARQ process number is at the maximum number by monitoring such progression status of the HARQ.

When the monitoring unit 125 detects the specific time period, the channel acquiring unit 121 acquires channel information pieces of some frequency resources or omits the acquisition of the channel information in the detected specific time period. The some frequency resources are, for example, resultant frequency resources (frequency resources F1, F10, F20, and so forth for example) obtained by filtering frequency resources F1, F2, F3, and so forth with a predetermined frequency interval.

When the monitoring unit 125 detects the specific time period, the average channel information calculator 122 calculates the average channel information using the channel information pieces of the some frequency resources or omits the calculation of the average channel information. When the calculation of the average channel information is omitted, the average channel quality calculated in a prior subframe may be reused.

Omitting the calculation of the average channel information can reduce the processing load to a larger extent than the case where the average channel information is calculated using the channel information pieces of the some frequency resources. Still, in the calculation of the average channel information, the average channel information in the past is used as described above. Thus, it is not preferable to keep omitting the calculation of the average channel information.

Thus, even in the specific time period, the average channel information calculator 122 calculates the average channel information using the channel information pieces of the some frequency resources at a certain frequency. In other words, the average channel information calculator 122 calculates the average channel information using the channel information pieces of the some frequency resources when the time period in which the calculation of the average channel information is omitted has continued for a predetermined period.

### (3) Processing Flows

Next, processing flows 1 and 2 of the allocation processing performed by the processor 120 are described.

In the processing flow 1, the average channel information calculator 122 calculates the average channel information using the channel information pieces of some frequency resources when the monitoring unit 125 detects the specific time period.

In the processing flow 2, the average channel information calculator 122 omits the calculation of the average channel information when the monitoring unit 125 detects the specific time period.

As described above, the processing is not limited to individual execution of the processing flow 1 or 2, and the processing may be performed while switching between the processing flows 1 and 2 as appropriate.

### (3.1) Processing Flow 1

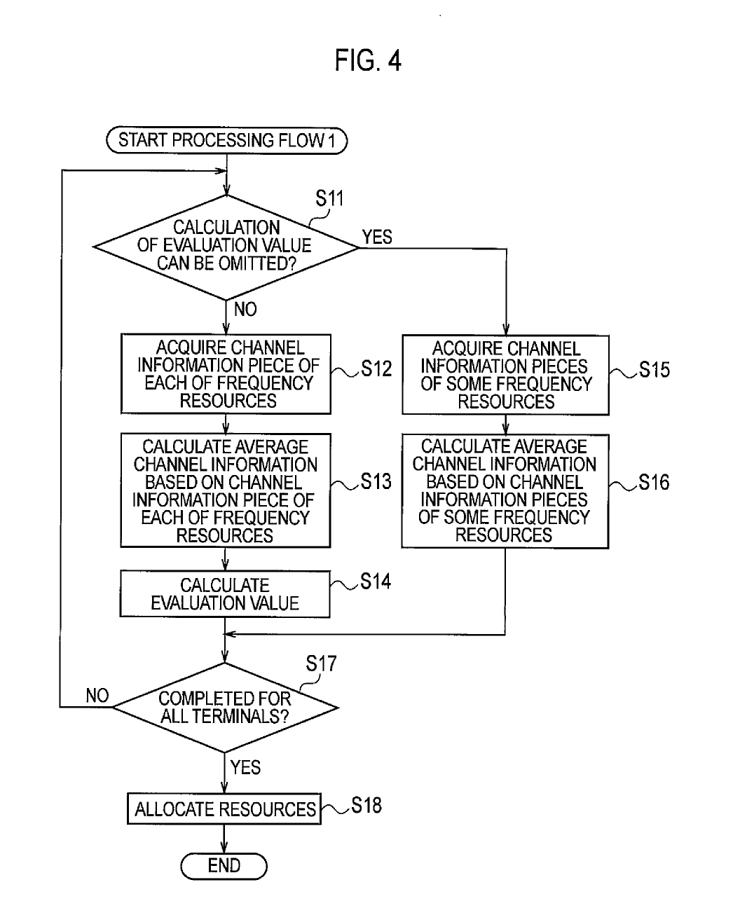

FIG. 4 is a flowchart showing the processing flow 1 of allocation processing. The processing flow 1 is performed in units of subframes.

When the monitoring unit 125 does not detect the specific time period for the radio terminal UE (step S11; NO), the channel information acquiring unit 121 acquires the channel information piece of each of the frequency resources F1, F2, F3, and so forth in step S12.

In step S13, the average channel information calculator 122 calculates the average channel information by averaging the channel information pieces acquired by the channel information acquiring unit 121 in the frequency direction and the time direction.

In step 14, the evaluation value calculator 123 calculates a metric (corresponding to the numerator) for allocation determination from the channel information piece and calculates the evaluation value for each of the frequency resources F1, F2, F3, and so forth on the basis of the average channel information calculated by the average information calculator 122 and the metric.

On the other hand, when the monitoring unit 125 detects the specific time period for the radio terminal UE (step S11; YES), the channel information acquiring unit 121 acquires the channel information pieces of the some frequency resources (e.g., F1, F20, F30, and so forth) in step S15.

In step S16, the average channel information calculator 122 calculates the average channel information by averaging the channel information pieces acquired for the some frequency resources by the channel information acquiring unit 121 in the frequency direction and the time direction. The calculated average channel information is stored in the storage unit 130 and is used for calculating the average channel information in a subsequent subframe. Note that after step S16, the calculation of the evaluation value is omitted.

When the processing is completed for all the radio terminals UE1, UE2, UE3, and so forth (step S17; YES), the resource allocation determination unit 124 performs frequency resource allocation using the evaluation values calculated by the evaluation value calculator 123. When the processing is not completed for all the radio terminals UE1, UE2, UE3 and so forth (step S17; NO), the processing returns to step S11.

### (3.2) Processing Flow 2

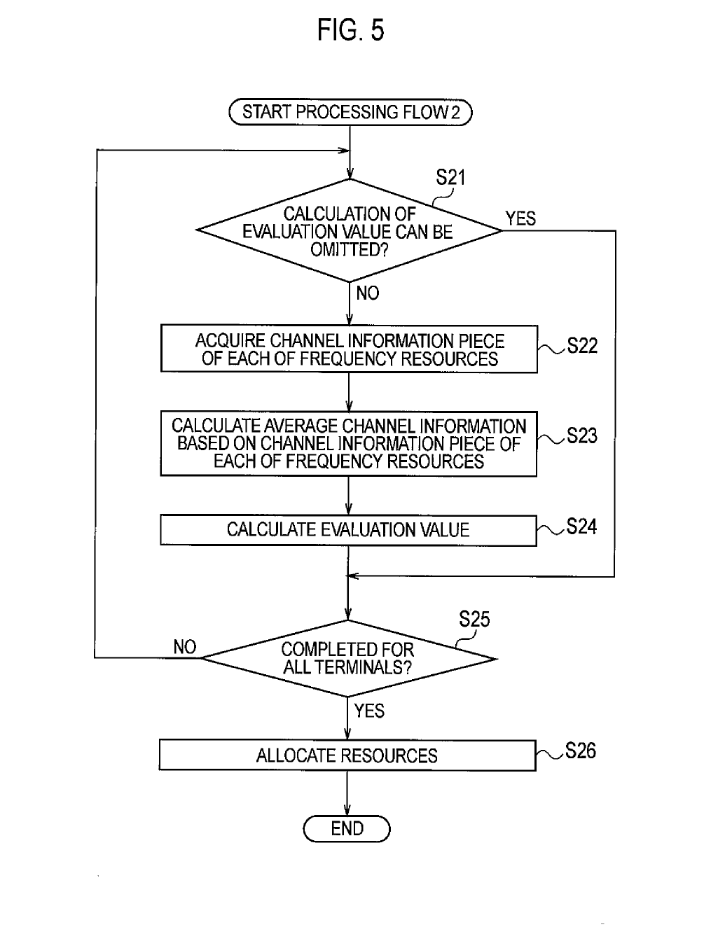

FIG. 5 is a flowchart showing the processing flow 2 of allocation processing.

The processing flow 2 is different from the processing flow 1 in that the cannel information acquiring unit 121 omits the acquisition of the channel information and the average channel information calculator 122 omits the calculation of the average channel information when the monitoring unit 125 detects the specific time period for the radio terminal UE (step S21; YES). Other points are the same as those in the processing flow 1.

### (4) Effect of the Embodiment

As described above, the average channel information calculator 122 calculates the average channel information using the channel information pieces of some frequency resources in plural frequency resources or omits the calculation of the average channel information in the specific time period in which the calculation of the evaluation value can be omitted. Thus, the processing load attributable to the calculation of the average channel information can be reduced.

Furthermore, by setting the subframe without data to be transmitted and received to and from the radio terminal UE as the specific time period, the processing load on the processor 120 for the subframe without data to be transmitted and received to and from the radio terminal UE can be reduced.

Similarly, by setting the subframe in which the frequency resource to be allocated to the radio terminal UE is reserved as the specific time period, the processing load on the processor 120 for the subframe in which the frequency resource to be allocated to the radio terminal UE is reserved can be reduced.

Moreover, by setting the subframe in which the HARQ process number is at the maximum number as the specific time period, the processing load on the processor 120 for the subframe in which the HARQ process number is at the maximum number can be reduced.

In the present embodiment, when the average information calculator 122 calculates the average channel information using the channel information pieces of some frequency resources, the channel information acquiring unit 121 acquires the channel information pieces of the some frequency resources. Thus, the processing load on the processor 120 can be reduced as compared with a case where the channel information pieces of all the frequency resources are acquired.

In the present embodiment, the channel information acquiring unit 121 omits the acquisition of the channel information when the average channel information calculator 122 omits the calculation of the average channel information. Thus, the processing load on the processor 120 can be further reduced.

In the present embodiment, the average channel information calculator 122 calculates the average channel information using the channel information pieces of some frequency resources when a time period in which the calculation of the average channel information is omitted has continued for a predetermined period (e.g., about five subframes). Average channel information in the past is used for the calculation of the average channel information. In the specific time period, reduction in accuracy of the average channel information can be prevented by calculating the average channel information at a certain frequency.

### (5) Other Embodiments

As described above, the details of the present invention have been disclosed by using the embodiment of the present invention. However, it should not be understood that the description and drawings which constitute part of this disclosure limit the present invention. From this disclosure, various alternative embodiments, examples, and operation techniques will be easily found by those skilled in the art.

### (5.1) First Modification

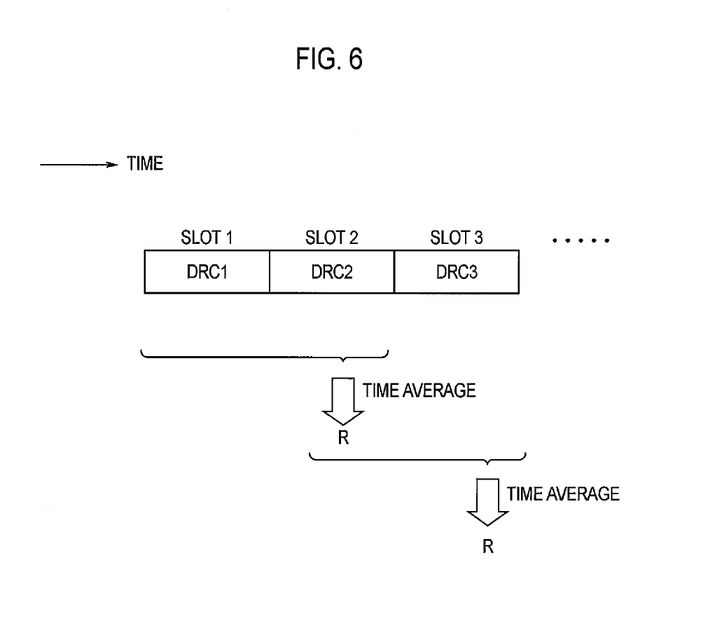

In the above descried embodiment, the radio communication system 1 is the FDMA radio communication system employing the OFDMA or the SC-FDMA. The present invention can also be applied to other radio communication systems as long as the radio communication system employs the proportional fairness scheme for the allocation processing. Operations of a radio base station 100 formed by applying the present invention to cdma2000 nx evolution-data only (hereinafter referred to as “EV-DO”) are described below with reference to FIG. 6. In EV-DO, the frequency resource is divided into time resources (e.g., 1/600 second) called slots to be allocated to the radio terminal UE.

The radio base station 100 performs allocation processing for efficiently allocating the slot to the radio terminal UE on the basis of a DRC received from the radio terminal UE. To be specific, the radio base station 100 calculates, as an evaluation value, DRC/R from an average transmission rate R in a predetermined slot period in the past and an instantaneous transmission rate DRC for each of the radio terminals UE1, UE2, and so forth. The slot is allocated to the radio terminal with the highest evaluation value. The transmission rate reflects the channel quality and in the present modification, the instantaneous transmission rate serves as the channel information, and the average transmission rate R serves as the average channel information.

In such a radio communication system, the processor 120 of the radio base station 100 allocates one of plural time resources to the radio terminal UE on the basis of the channel information indicating the channel quality between the radio terminal UE and the radio base station 100. The processor 120 acquires the channel information piece for each of plural time resources and averages the acquired channel information pieces to calculate the average channel information. Then, the processor 120 calculates the evaluation value to be used for the determination of the time resource to be allocated to the radio terminal UE on the basis of the acquired channel information and the calculated average channel information. The processor 120 omits the calculation of the average channel information in a specific time period in which the calculation of the evaluation value can be omitted.

### (5.2) Second Modification

In the above described embodiment, the allocation processing based on the proportion fairness scheme is described. The present invention may be applied to the allocation processing based on the proportion fairness scheme as long as the average channel information is used.

### (5.3) Third Modification

In the above described embodiment, when the monitoring unit 125 detects the specific time period, the channel information acquiring unit 121 acquires the channel information pieces of some frequency resources. Instead, the channel information pieces of all the frequency resources may be acquired. In this case, the average channel information calculator 122 calculates the average channel information using only some of the channel information pieces in the channel information pieces of all the frequency resources.

As described above, the present invention naturally includes various embodiments which are not described herein. Accordingly, the technical scope of the present invention should be determined only by the matters to define the invention in the scope of claims regarded as appropriate based on the description.

Note that the entire content of Japanese Patent Application No. 2009-151661 (filed on Jun. 25, 2009) is incorporated herein by reference.

### INDUSTRIAL APPLICABILITY

As described above, the radio base station and the resource allocating method according to the present invention can reduce the processing load attributable to the calculation of the average channel information when the allocation processing based on the average channel information is performed and thus are advantageously used in radio communications such as a mobile communication.

1. A radio base station comprising an allocation processor configured to allocate any of a plurality of frequency resources to a radio terminal on the basis of a channel information piece indicating a channel quality between the radio terminal and the radio base station, the allocation processor configured to:
periodically acquire the channel information piece of each of the plurality of frequency resources,
calculate average channel information by averaging the acquired channel information pieces in a frequency direction and a time direction, and
calculate an evaluation value to be used for determining a frequency resource to be allocated to the radio terminal on the basis of the acquired channel information pieces and the calculated average channel information, wherein
in a specific time period in which the calculation of the evaluation value is omissible, the allocation processor calculates the average channel information using the channel information pieces of some of the plurality of frequency resources or omits the calculation of the average channel information.

2. The radio base station according to claim 1, wherein
the specific time period is a time period in which there is no data to be transmitted to or to be received from the radio terminal using any of the plurality of frequency resources.

3. The radio base station according to claim 1, wherein
the specific time period is a time period in which any of the plurality of frequency resources is reserved for allocation to the radio terminal.

4. The radio base station according to claim 1, wherein
hybrid automatic repeat request, which is a combination of forward error correction and automatic repeat request, is employed for communications between the radio base station and the radio terminal, and
the specific time period is a time period in which the number of retransmission processes performed in parallel based on the hybrid automatic repeat request is at a maximum number.

5. The radio base station according to claim 1, wherein
if the average channel information is calculated using the channel information pieces of the some frequency resources, the allocation processor acquires the channel information pieces of the some frequency resources.

6. The radio base station according to claim 1, wherein
if the calculation of the average channel information is omitted, the allocation processor omits the acquisition of the channel information pieces.

7. The radio base station according to claim 1, wherein
if the calculation of the average channel information is omitted, and if a time period of omitting the calculation of the average channel information continues for a predetermined period, the allocation processor calculates the average channel information using the channel information pieces of the some frequency resources.

8. A radio base station comprising an allocation processor configured to allocate any of a plurality of time resources to a radio terminal on the basis of a channel information piece indicating a channel quality between the radio terminal and the radio base station,
the allocation processor configured to
acquire the channel information piece of each of the plurality of time resources,
calculate average channel information by averaging the acquired channel information pieces, and
calculate an evaluation value to be used for determining a time resource to be allocated to the radio terminal on the basis of the acquired channel information pieces and the calculated average channel information, wherein
in a specific time period in which the calculation of the evaluation value is omissible, the allocation processor omits the calculation of the average channel information.

9. A resource allocating method for allocating any of a plurality of frequency resources to a radio terminal on the basis of a channel information piece indicating a channel quality between the radio terminal and the radio base station, the resource allocating method comprising:
an acquisition step of periodically acquiring the channel information piece of each of the plurality of frequency resources;
a first calculation step of calculating average channel information by averaging the channel information pieces, acquired in the acquisition step, in a frequency direction and a time direction; and
a second calculation step of calculating an evaluation value to be used for determining a frequency resource to be allocated to the radio terminal, on the basis of the channel information pieces acquired in the acquisition step and the average channel information calculated in the first calculation step, wherein
in a specific time period in which the calculation of the evaluation value is omissible in the second calculation step, the first calculation step includes calculating the average channel information using the channel information pieces of some of the plurality of frequency resources or omitting the calculation of the average channel information.

10. A resource allocating method for allocating any of a plurality of time resources to a radio terminal on the basis of a channel information piece indicating a channel quality between the radio terminal and the radio base station, the resource allocating method comprising:
an acquisition step of acquiring the channel information piece of each of the plurality of time resources;
a first calculation step of calculating average channel information by averaging the channel information pieces acquired in the acquisition step; and
a second calculation step of calculating an evaluation value to be used for determining a time resource to be allocated to the radio terminal, on the basis of the channel information pieces acquired in the acquisition step and the average channel information calculated in the first calculation step, wherein
in a specific time period in which the calculation of the evaluation value is omissible in the second calculation step, the first calculation step includes omitting the calculation of the average channel information.
